(19) United States
(12) Patent Application Publication
(10) Pub. No.: US 2019/0208788 A1
(43) Pub. Date: Jul. 11, 2019

(54) AN INSECTICIDE COATING COMPOSITION AND METHOD THEREOF

(71) Applicant: NONTOXICO LTD., Ramat-Gan (IL)

(72) Inventors: Raziel KUBASHI LEVI, Ramat-Gan (IL); Martin WIRTSCHAFTER, Ramat Gan (IL)

(21) Appl. No.: 16/311,925

(22) PCT Filed: Jun. 21, 2017
(86) PCT No.: PCT/IL2017/050686

§ 371 Date: Dec. 20, 2018

Related U.S. Application Data
(60) Provisional application No. 62/353,065, filed on Jun. 22, 2016.

(51) Int. Cl. A01N 59/14; A01N 37/04; A01N 37/44; A01N 25/12; A01N 25/06

(52) U.S. Cl. CPC A01N 59/14; A01N 37/04; A01N 59/08; A01N 25/12; A01N 25/06; A01N 37/44

(57) ABSTRACT

The present invention discloses a powdered insecticide coating composition comprising a mixture of: boric acid compound in a range of about 40% to 60% by weight, an organic compound in a range of about 40% to 60% by weight and aminopolycarboxylic acid compound in a range of about 1% by weight, and methods thereof.

### FIELD OF THE INVENTION

The present invention relates to novel compositions and methods for insecticide. More particularly the present invention relates to a coating composition which provides a powdered barrier around the insect cuticle.

### BACKGROUND OF THE INVENTION

A variety of compositions have been proposed for insecticide.

US patent app. No. 2014039013 provides chemical modulators of insect olfactory receptors. In particular, compounds and compositions are provided that can inhibit host targeting functions in insects. Method of employing such agents, and articles incorporating the same, are also presented.

PCT app. WO2006044060 relates to protective coated fruits and vegetables, and methods for the treatment of plants that reduces the incidence of insect and sunburn damage, and other stress-induced disorders of horticultural crops.

U.S. Pat. No. 5,221,535 provides a process of preparing an emulsion of a solubilised compound, the compound being soluble in a physiologically acceptable aqueous or nonaqueous solvent, the process comprising: (1) adding a complexing agent to at least one solvent containing at least one compound, the agent being capable of forming a compound: agent complex; (b) adding an emulsifier to the solvent containing the compound and the complexing agent; and (c) forming an emulsion. The invention also provides a process of preparing a dispersion of a compound which is insoluble in a physiologically acceptable aqueous or nonaqueous solvent but only soluble in a physiologically unacceptable solvent, said process comprising: (a) adding said compound to at least one physiologically acceptable solvent; (b) adding a complexing agent to the compound plus solvent of (a); (c) further adding an emulsifier to the compound plus solvent plus complexing agent of (b); (d) forming a dispersion of said compound in said physiologically acceptable solvent

U.S. Pat. No. 5,188,837 presents a microsuspension system and method for its preparation. The microsuspension contains lipospheres, which are solid, water-insoluble microparticles that have a layer of a phospholipid embedded on their surface.

The core of the liposphere is a solid substance to be delivered, or a substance to be delivered that is dispersed in an inert solid vehicle, such as a wax.

In view of the above, it is still a long felt and unmet need for a composition with minimal toxicity that is specifically useful for insect-control in short time and effective manner.

### SUMMARY OF THE INVENTION

It is hence one object of the present invention to provide a powdered insecticide coating composition comprising a mixture of: boric acid compound in a range of about 40% to 60% by weight, an organic compound in a range of about 40% to 60% by weight and aminopolycarboxylic acid compound in a range of about 1% by weight.

It is another object of the present invention to provide a sprayable insect control composition, comprising: boric acid compound in a range of about X % by weight, an organic compound in a range of about Y % by weight and aminopolycarboxylic acid compound in a range of about Z % by weight.

It is also an object of the present invention to provide the composition as mentioned in any of the above, wherein said composition is with high solubility.

It is also an object of the present invention to provide the composition as mentioned in any of the above, wherein the boric acid when reacts with the organic compound provides high concentration of nanoparticle crystals of the boric acid.

It is also an object of the present invention to provide the composition as mentioned in any of the above, wherein additionally comprising at least one substance selected from the group consisting of inorganic salt such asmagnesium chloride, calcium chloride, clay mineral such as Kaolinite, silica and any mixture thereof.

It is also an object of the present invention to provide the composition as mentioned in any of the above, wherein the organic compound is selected from the group consisting of malic acid, oxalic acid, citric acid and a mixture thereof.

It is also an object of the present invention to provide the composition as mentioned in any of the above, wherein the aminopolycarboxylic acid is EDTA.

It is also an object of the present invention to provide the composition as mentioned in any of the above, wherein the composition is further defined as having a particle size of approximately 0.1 to 1 mm.

It is also an object of the present invention to provide the composition as mentioned in any of the above, wherein the composition when dispersed on an insect provides a thin coating layer upon the cuticle of the insects for inhibition of insect host sensing.

It is also an object of the present invention to provide the composition as mentioned in any of the above, wherein the composition has a low toxicity level.

It is also an object of the present invention to provide the composition as mentioned in any of the above, wherein the composition inhibits the function of the sensors or/and the spiracle of the insect by forming a barrier around the insect cuticle.

It is also an object of the present invention to provide the composition as mentioned in any of the above, wherein the boric acid exhibit a synergistic effect when combined with organic compound thereby, increasing the efficacy of the composition for controlling insects.

It is another object of the present invention to provide a dispersing device for delivering an aerosolized spray of insect repellent, comprising: a housing having an internal cavity containing an insect repellent composition; and a control valve for delivering the repellent from the cavity to a selected site; wherein the composition comprising a mixture of: boric acid in a range of about 40% to 60% by weight, an organic compound in a range of about 40% to 60% by weight and aminopolycarboxylic acid in a range of about 1% by weight.

It is another object of the present invention to provide a method for controlling an insect comprising steps of:
a. providing powdered insecticide coating composition comprising a mixture of: boric acid in a range of about 40% to 60% by weight, an organic compound in a range of about 40% to 60% by weight and aminopolycarboxylic acid in a range of about 1% by weight.
b. dispersing the composition upon the insect body surface.

It is also an object of the present invention to provide the method as mentioned in any of the above, wherein additionally comprising steps of providing at least one substance selected from the group consisting of triglyceride such as inorganic salt such as Magnesium chloride or/and calsium chloride, clay mineral such as Kaolinite, silica and any mixture thereof.

It is also an object of the present invention to provide the method as mentioned in any of the above, wherein the step of providing organic compound selected from the group consisting of malic acid, oxalic acid, citric acid and a mixture thereof.

It is also an object of the present invention to provide the method as mentioned in any of the above, wherein the step of providing aminopolycarboxylic acid is EDTA.

It is also an object of the present invention to provide the method as mentioned in any of the above, wherein the step of dispersing the composition on an insect is providing a thin coating layer around the cuticle of the insects for inhibition of insect host sensing.

It is also an object of the present invention to provide the method as mentioned in any of the above, wherein the step of providing a composition having a low toxicity level.

It is also an object of the present invention to provide the method as mentioned in any of the above, wherein additionally comprising steps of forming a barrier around the insect cuticle.

It is also an object of the present invention to provide the method as mentioned in any of the above, wherein additionally comprising steps of the boric acid exhibiting a synergistic effect when combined with organic compound thereby, increasing the efficacy of the composition for controlling insects

### BRIEF DESCRIPTION OF THE DRAWINGS

In the following description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

In the accompanying drawing:

FIGS. 1-7 present the insect repellent composition effect upon a group of ants according to relative time period, of the present invention; and,

FIG. 8 presents a graph of the number of dead ants vs time period;

### DETAILED DESCRIPTION OF THE PREFERRED EMBODIMENTS

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

The essence of the present invention is to provide insect repellent compositions. The insecticide coating composition comprising a combination of boric acid compound, an organic compound and aminopolycarboxylic acid compound.

The composition is directed to inhibiting a wide variety of insects.

The composition may further inhibit the function of the sensors or/and the spiracle of the insect by forming a coating layer or barrier upon the insect body surface.

The term “Insect” herein refers to a class of invertebrates within the arthropod phylum that have a chitinous exoskeleton, a three-part body (head, thorax and abdomen), three pairs of jointed legs, compound eyes and one pair of antennae.

More particularly to an arthropod, an invertebrate animal having an exoskeleton (external skeleton), a segmented body, and jointed appendages. The insect has a cuticle which forms the major part of the integument of the Arthropoda. The cuticle is the external “skin”, or “shell”, a single layer of ectodermal epithelium. That layer is attached to the external or distal surface of the deepest layer, the non-cellular internal membrane of the integument.

The present invention provides a powdered insecticide coating composition comprising a mixture of: boric acid compound in a range of about 40% to 60% by weight, an organic compound in a range of about 40% to 60% by weight and aminopolycarboxylic acid in a range of about 1% by weight.

The combination of the boric acid compound, the organic compound and aminopolycarboxylic compound are in a predefined ratio controlling the insect and exterminate it in an effective manner in short time. The ration is selected from the group consisting of: 2:3:0.1, respectively.

The present invention further provides a sprayable insect control composition, comprising: boric acid in a range of about 40% to 60% by weight, an organic compound in a range of about 40% to 60% by weight and aminopolycarboxylic acid in a range of about 1% by weight.

In other embodiments of the present invention, the composition is with high solubility in aqueous solution.

In other embodiments, the boric acid compound when mixed with the organic compound provides high concentration of nanoparticles crystals of boric acid.

In other embodiments of the present invention, the composition additionally comprising at least one substance selected from the group consisting of about 10% to 20% inorganic salt such as magnesium chloride or/and calcium chloride, about 80% to 90% inert material such as clay mineral comprising Kaolinite, silica (e.g. silicon dioxide) and any mixture thereof.

The ratio between the additional substance and the composition comprising boric acid, organic compound and EDTA is 1:1 or 2:3 respectively.

In other embodiments of the present invention, the organic compound enhancing the efficacy and solubility of the boric acid compound.

In other embodiments of the present invention, the detergent SLS combined with triglyceride Stearin enables the adherent of the coating formation to the insect body surface. Since the insect body is covered with a hydrophobic fraction there is an improved attachment and adsorption of the triglyceride upon the insect body whilst the SLS is a binding substance which allows conjugation between the hydrophobic fraction to the hydrophilic fraction. This results in a higher entropic state which causes non-polar molecules to clump together to reduce the surface area exposed to water and decrease the entropy of the system.

In other embodiments of the present invention, the Magnesium sulfate salt is an hygroscopic material which enables the boric acid compound to be dissolved and an improved insecticide with low toxicity to the environment.

In other embodiments of the present invention, the organic compound is selected from the group consisting of malic acid, oxalic acid, citric acid and a mixture thereof.

In other embodiments of the present invention, the aminopolycarboxylic acid is EDTA.

In other embodiments of the present invention, the composition is further defined as having a particle size of approximately 0.1 to 1 mm.

In other embodiments of the present invention, the additional substance may be used as a coating, shell like, envelope enclosing like or capsulation fraction for the composition comprising boric acid, organic compound and EDTA.

In other embodiments of the present invention, the composition may be provided in solid form which includes granules, dusts, powder, miniature pellets and any combination thereof.

In other embodiments of the present invention, the composition when dispersed on an insect provides a thin coating layer around the cuticle or the epicuticle of the insects for inhibition of insect host sensing.

In other embodiments of the present invention, the composition has a low toxicity level. Measuring Toxicity is divided to Acute toxicity and Chronic toxicity. This refers to how poisonous an insecticide is to a human, animal, or plant after a single short-term exposure. Acute toxicity is used to describe effects which appear promptly, or within 24 hours of exposure. An insecticide with a high acute toxicity is deadly even when a very small amount is absorbed. Acute toxicity levels are used as a way to assess and compare how poisonous insecticide are. The acute toxicity of an insecticide is used as the basis for the warning statements on the label. Acute toxicity may be measured as acute oral toxicity, acute dermal toxicity, and acute inhalation toxicity

To figure out how acutely toxic an insecticide is, laboratory animals were exposed to short-term doses of the insecticide composition of the present invention. Experimental doses were given orally, as well as put on the eyes, skin, and in the air that the test animals breathe. The animals are then observed carefully for changes.

Lethal Dose Fifty (LD50)

“Lethal Dose Fifty” (LD50) is one way the toxicity of chemicals are measured. LD50 is the amount of an insecticide that has killed half of the animals in a laboratory test. The LD50 is found for both dermal and oral routes of exposure. For example, an acute oral LD50 indicates the amount of insecticide swallowed that has killed half of the animals tested.

The smaller the LD50 value, the less chemical required to kill half of the test animals, and the more poisonous the insecticide. An insecticide with a dermal LD50 of 25 (rabbit) is more poisonous than an insecticide with a dermal LD50 of 2000 (rabbit). LD50's do not tell us how a chemical acts, nor do they tell us how sensitive different organs within an animal or human might be. They simply tell us how much of the chemical it takes to kill half of the test animals. LD50's for different chemicals can only be compared if the same test animal was used, and even then it cannot be taken as an indication of the ful toxic potential of either chemical.

Insecticide LD50 values are measured in units of weight called “milligrams” per “kilogram” (mg/kg). A single paper clip weighs about one gram. Cutting the clip into 1000 equal parts will make pieces that weigh one milligram each. There are approximately 28,000 milligrams in an ounce. A kilogram is about equal to 2.2 pounds. The LD50 value refers to the number of milligrams of insecticide that was needed to kill half of the test animals for each kilogram of the animal's body weight. For example, an acute oral LD50 of 5 mg/kg for insecticide A (rats) indicates that it is toxic when there are 5 mg of this chemical given orally for every kilogram (or 2.2 pounds) of the animal's weight.

Another way of expressing how much insecticide is involved in toxic doses is referred to as “parts per million”, abbreviated “ppm”. One part per million means that for every million parts of a solution or mixture, there is one part of the substance being measured. The measures mg/kg and ppm are used interchangably since a milligram is one millionth of a kilogram. Other measures that you might come across when looking at the toxicity of an insecticide include: “parts per billion” (ppb) and “parts per trillion” (ppt).

Lethal Concentration Fifty (LC50)

To figure out the “acute inhalation toxicity” of an insecticide, known amount of the insecticide was added to air. The amount that causes half of the animals to die is the “Lethal Concentration Fifty” (LC50) of the insecticide. The lower the LC50 value, the more poisonous the insecticide. Lethal Concentration Fifty is measured in milligrams per liter (mg/I) or ppm and sometimes in milligrams per cubic meter (mg/m3).

Chronic Toxicity Measures

There is no standard measure like LD50 for chronic toxicity studies. Often the length of the experiment is in days, months, or years and the amount of each dose is stated. For example, a study of chronic oral toxicity might look like this: 8 milligrams of insecticide were fed to rats daily for two years. No symptoms of poisoning appeared.

Two classes of insecticides, the organophosphates and carbamates, can slowly poison by attacking an essential body chemical called “cholinesterase”. The chronic exposure to organophosphate insecticides can be measured by monitoring changes in blood cholinesterase levels. In humans, decreased blood cholinesterase levels are a sure sign that exposure to these types of insecticides should be avoided until the level is measured as being normal again.

The following Table 1 indicates the four categories of insecticide toxicity:

TABLE 1
Categories of Acute Toxicity

| | Signal Word | Oral | Dermal | | Approximate Oral |
|---|---|---|---|---|---|
| | Required on | Ld50 | LD50 | Inhalation | dose that can Kill |
| Category | Label | Mg/kg | mg/kg | LC50 mg/l | an Average Person |
| I Highly | DANGER- | From 0 | From 0 | From 0 | A few drops to 1 |
| toxic | *[Poison! Skull | to 50 | to 200 | to 0.2 | teaspoon full [or a |
| | Crossbones] | | | | few drops on the |
| | | | | | skin] |
| II Moderately | WARNING! | From 50 | From 200 | From 0.2 | Over 1 teaspoonful |
| Toxic | | to 500 | to 2000 | to 2 | to 1 ounce |
| III Slightly | CAUTION!! | From 500 | From 2000 | From 2.0 | Over 1 ounce to 1 |
| Toxic | | to 5000 | to 20,000 | to 20 | pint or 1 pound |
| IV Relatively | CAUTION!! | More than | More than | Greater than | Over 1 pint or 1 |
| Non-toxic | | 5000 | 20,000 | 20 | pound |

In other embodiments of the present invention, the boric acid compound exhibits a synergistic effect when combined with an organic compound thereby, increasing the efficacy of the composition for controlling insects.

In other embodiments of the present invention, the composition may be based upon a Controlled-release mechanism. Thereby release of the active ingredient at a predetermined rate in order to maintain a constant compound concentration for a specific period of time. This can be achieved through a variety of formulations.

The present invention further provides a dispersing device for delivering an aerosolized spray of insect repellent, comprising: a housing having an internal cavity containing an insect repellent composition; and a control valve for delivering the repellent from the cavity to a selected site; wherein the composition comprising a mixture of: boric acid in a range of about 40% to 60% by weight, an organic compound in a range of about 40% to 60% by weight and aminopolycarboxylic acid in a range of about 1% by weight. The present invention further provides a method for controlling an insect comprising steps of:
a. providing powdered insecticide coating composition comprising a mixture of: boric acid in a range of about 40% to 60% by weight, an organic compound in a range of about 40% to 60% by weight and aminopolycarboxylic acid in a range of about 1% by weight.
b. dispersing the composition upon the insect body surface.

It is further within the scope of the present invention to provide the method as defined in any of the above, additionally comprising steps of providing at least one substance selected from the group consisting of inorganic salt such as Magnesium chloride or/and calcium chloride, clay mineral such as Kaolinite, silica and any mixture thereof.

It is further within the scope of the present invention to provide the method as defined in any of the above, the step of providing organic compound is malic acid, citric acid or oxalic acid.

It is further within the scope of the present invention to provide the method as defined in any of the above, the step of providing aminopolycarboxylic acid is EDTA.

It is further within the scope of the present invention to provide the method as defined in any of the above, the step of dispersing the composition on an insect is providing a thin coating layer around the cuticle of the insect for inhibition of insect host sensing.

It is further within the scope of the present invention to provide the method as defined in any of the above, the step of providing a composition having a low toxicity level.

It is further within the scope of the present invention to provide the method as defined in any of the above, additionally comprising steps of forming a barrier around the insect cuticle, the breathing spiracles, sensory hairs and organs.

It is further within the scope of the present invention to provide the method as defined in any of the above, additionally comprising steps of the boric acid exhibiting a synergistic effect when combined with organic compound thereby, increasing the efficacy of the composition for controlling insects.

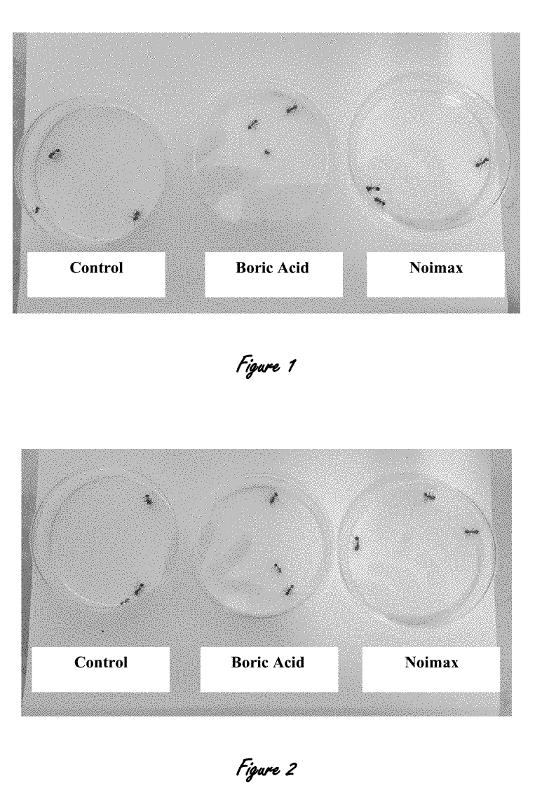

Reference is now made to FIGS. 1-7 which present the insect repellent composition effect upon a group of ants according to relative time period.

Three groups of messor ebeninus ants were selected such that the first group was exposed to the composition of the present invention comprising about 20 to about 30% of boric acid (e.g. Noimax), the second was group exposed to 100% boric acid and a third control group. The experiment was done in conventional room conditions (temperature 25° c., 47% humidity).

Every 30 mins each group was examined. After 30 mins the Noimax group should distress signs the other group didn't show any outstanding signs.

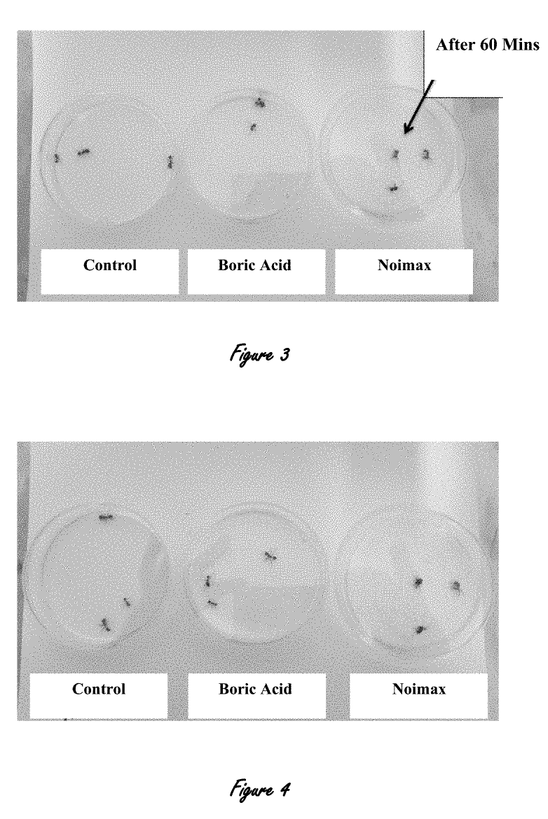

As illustrated in FIG. 3 after 60 mins the Noimax group contained dead ants whilst the other group was in the same condition without any outstanding effect or signs.

Table 2 below summarizes the composition effect upon each group of ant when exposed to the composition of the present invention comprising about 20 to about 30% of boric acid (e.g. Noimax), to 100% boric acid and a the control group.

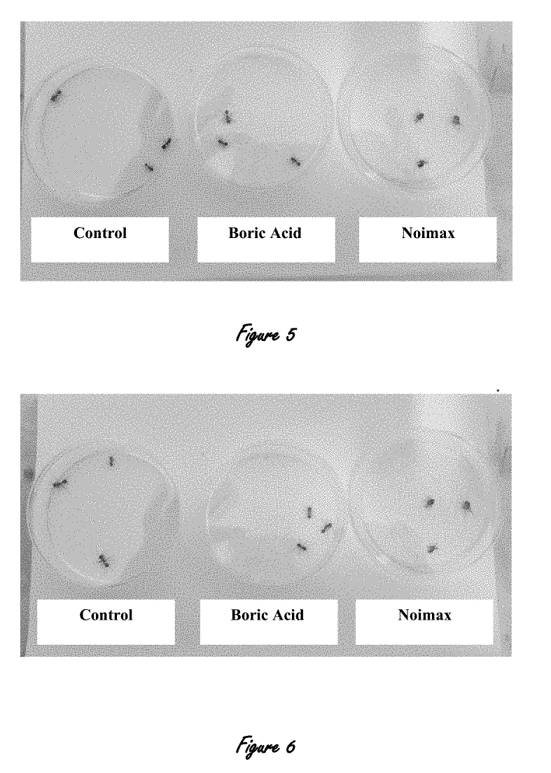

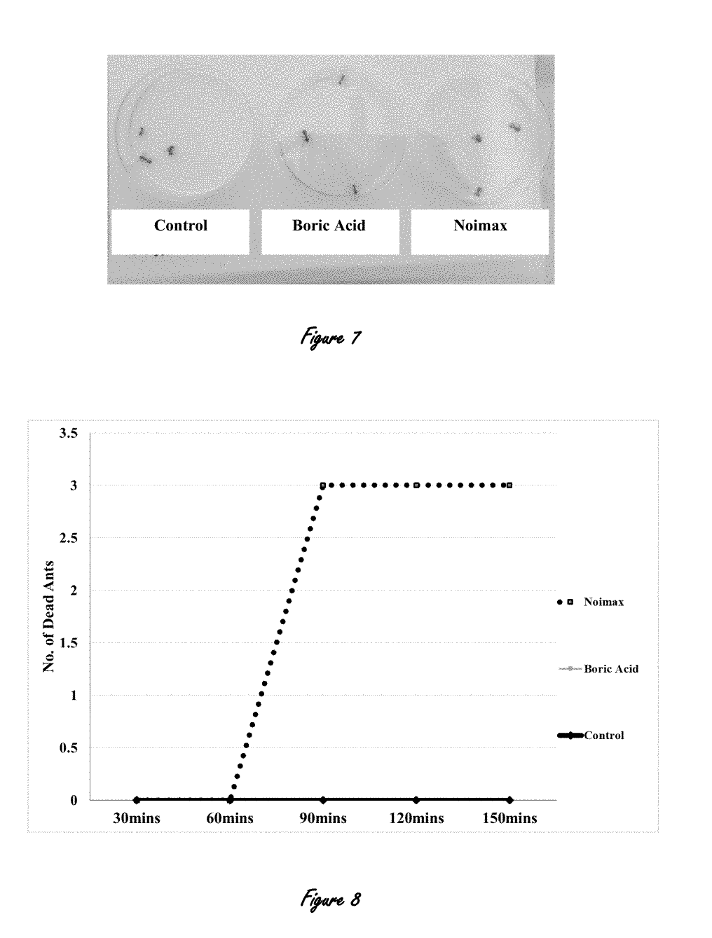

TABLE 2

| | Sample A | Sample B | Sample C |
|---|---|---|---|
| | Noimax group | Boric acid group | Control group |
| Time (mins) | (dead ants presented) | (dead ants presented) | (dead ants presented) |
| 0 (FIG. 1) | — | — | — |
| 30 (FIG. 2) | — | — | — |
| 60 (FIG. 3) | ✓ | — | — |
| 90 (FIG. 4) | ✓ | — | — |
| 120(FIG. 5) | ✓ | — | — |
| 150(FIG. 6) | ✓ | — | — |
| 720(FIG. 7) | ✓ | — | — |

Reference is now made to FIG. 8 which presents a graph of the number of dead ants in three groups samples when exposed to the composition of the present invention comprising about 20 to about 30% of boric acid (e.g. Noimax), to 100% boric acid and the control group vs. time period. As illustrated the Noimax was highly effective after a short time period.

1.-21. (canceled)

22. A non-toxic CATEGORY 4 insecticide coating composition comprising a mixture of boric acid in a range of 20% to 30% by weight, detergent SLS combined with triglyceride Stearin in a range of about 40% to 60% by weight and aminopolycarboxylic acid in a range of about 1% by weight,
said composition dispersable upon the insect body surface for providing a thin coating layer around the cuticle, breathing spiracles, sensory hairs and organs of the insects and inhibiting insect host sensing.

23. The composition of claim 22, further comprising at least one substance selected from the group consisting of inorganic salt such as Magnesium chloride or/and calcium chloride, clay mineral such as Kaolinite, silica and any mixture thereof.

24. The composition of claim 22, further comprising a compound selected from the group consisting of malic acid, oxalic acid, citric acid and a mixture thereof.

25. A method for controlling an insect comprising steps of:
a. providing a non-toxic CATEGORY 4 insecticide coating composition comprising a mixture of boric acid in a range of about 20% to 30% by weight, detergent SLS combined with triglyceride Stearin in a range of about 40% to 60% by weight and aminopolycarboxylic acid in a range of about 1% by weight;
b. dispersing said composition upon the insect body surface; and
c. providing a thin coating layer around the cuticle, breathing spiracles, sensory hairs and organs of the insects and inhibiting insect host sensing.

26. The method of claim 25, further comprising providing at least one substance selected from the group consisting of inorganic salt such as Magnesium chloride or/and calcium chloride, clay mineral such as Kaolinite, silica and any mixture thereof.

27. The method of claim 25, comprising steps of providing organic compound selected from the group consisting of malic acid, oxalic acid, citric acid and a mixture thereof.
